(19) United States
(12) Patent Application Publication
(10) Pub. No.: US 2010/0063965 A1
(43) Pub. Date: Mar. 11, 2010

(54) CONTENT PROCESSOR, CONTENT PROCESSING METHOD, AND CONTENT PROCESSING PROGRAM

(76) Inventors: Ken Hanazawa, Tokyo (JP); Masahiro Iwadare, Tokyo (JP); Kyoji Hirata, Tokyo (JP)

Correspondence Address: Mr. Jackson Chen, 6535 N. STATE HWY 161, IRVING, TX, 75039, US

(21) Appl. No.: 12/595,346

(22) PCT Filed: Apr. 25, 2008
(86) PCT No.: PCT/JP2008/058019

§ 371 Date: Oct. 9, 2009

(30) Foreign Application Priority Data
Apr. 27, 2007 (JP) 2007-119393

(51) Int. Cl. G06F 17/30

(52) U.S. Cl. 707/723; 707/722; 707/E17.014

(57) ABSTRACT

To provide a content processing technique which enables to prevent a reading person from easily guessing the fact of hiding and hidden information, and to obtain a content having natural information close to information of its original content before hiding. A content processor includes a search means which searches contents having information similar to a part excluding a part to be hidden in the original content, an arithmetic means which calculates non-similarity which shows the degree of non-similarity of each content obtained by the search means to the part to be hidden of the contend, and a selection means which selects the content which is the least similar to the part to be hidden out of the contents searched by the search means.

### TECHNICAL FIELD

The present invention relates to a content processing technique for hiding a specific portion in a content, and particularly to a content processing technique capable of preventing readers from easily inferring the fact that hiding is applied and the hidden data, and capable of providing a content with natural data close to original data in the content before hiding.

### BACKGROUND ART

In view of streamlining of business and improvement of productivity, companies sometimes use what is generally called outsourcing, that is, contracting out of business operations to external companies such as business partners or associated companies. In such a case, when development is outsourced to a business partner, for example, there are phases in which confidential papers such as requirements definition documents or specifications should be presented to the outsourcing firm to request cooperative development.

In such a case, although the company that uses outsourcing can secure manpower to reduce the time to complete development, there arises a risk of information leakage by presenting highly confidential information (which will be sometimes referred to as confidential content hereinbelow), including documents and photographs, to the outside of the company. Thus, companies take several kinds of measures in presenting confidential contents containing important development information to the outside, represented by conclusion of confidentiality agreement.

For example, a common case in which a confidential document, i.e., the confidential content, is presented to the outside of a company involves a method of hiding a keyword undesired to be disclosed to the outside of the company by substituting it with another character string.

Alternatively, a method may be sometimes taken comprising, rather than presenting a specification containing trade secret information to an outsourcing firm, acquiring a similar document having data close to that in the specification, and disclosing a difference between the acquired similar document and the original specification. In this case, there is a known technique of similar document search disclosed in Patent Document 1, for example, for searching for a document having data equivalent to or similar to that in a certain document.

The invention in Patent Document 1 discloses a technique of similarity search focusing upon similarity of text information. In particular, Patent Document 1 proposes a technique of, once a document as a content is exemplified as a search condition, comparing feature information such as text information contained in the exemplified document with feature information such as text information contained in a stored document, and multiplying the result with weight values to calculate an overall evaluation value, which is defined as a document-level similarity, and outputting documents in the descending order of the similarity as a result of search.

Patent Document 1: JP-P2000-148793A

### DISCLOSURE OF THE INVENTION

### Problems to be Solved by the Invention

In disclosing a confidential document as a confidential content to the outside of a company, for example, the conventional method as described above poses problems as follows:

A first problem is that substitution of character strings may sometimes obscure the intention of the whole document, leading to miscommunication of the gist of development with readers.

A second problem is that the fact that hiding is applied to a confidential document per se can be easily figured out. Although not affecting much the mutual trust-based relationship between the entruster and contractor, this is not always preferable when considering smooth communication in achieving the development mission.

A third problem is that a hidden keyword may be inferred from a context.

The technique in Patent Document 1, however, merely involves search of similar documents, and it does not take account of the object that a specific portion should be hidden in a document. Therefore, the technique could not solve the aforementioned problems.

Moreover, there is also no other conventional technique that can provide a document natural to readers while hiding a specific portion, and the problems as described above could not be solved. Consequently, in presenting a confidential document to an outsourcing firm, the document must be manually re-created anew in most cases, which is a cumbersome operation.

Therefore, problems to be solved by the present invention are to provide a content processing technique capable of preventing readers from easily inferring the fact that hiding is applied and the hidden data, while providing a content with natural data close to that in the original content before hiding.

### Means for Solving the Problems

The present invention for solving the aforementioned problems is a content processing apparatus comprising: searching means for searching for a content having contents similar to those in portions in an original content exclusive of a portion to be hidden; and calculating means for calculating a degree of dissimilarity, which indicates the level of dissimilarity of each content obtained by said searching means to the portion to be hidden in said original content.

The present invention for solving the aforementioned problems is also a content processing method comprising: a searching step of searching for a content having contents similar to those in portions in an original content exclusive of a portion to be hidden; a calculating step of calculating a degree of dissimilarity, which indicates the level of dissimilarity of each content obtained by said searching step to the portion to be hidden in said original content; and a selecting step of selecting a content having a high level of dissimilarity to said portion in the content to be hidden out of contents searched by said searching step based on the degree of dissimilarity calculated by said calculating step.

The present invention for solving the aforementioned problems is also a program for an information processing apparatus, said program causing the information processing apparatus to function as: searching processing of searching for a content having contents similar to those in portions in an original content exclusive of a portion to be hidden; calculating processing of calculating a degree of dissimilarity, which indicates the level of dissimilarity of each content obtained by said searching processing to the portion to be hidden in said original content; and selecting processing of selecting a content having a high level of dissimilarity to said portion in the content to be hidden out of contents searched by said searching processing based on the degree of dissimilarity calculated by said calculating processing.

### EFFECTS OF THE INVENTION

According to the present invention, there is provided a content processing technique capable of preventing readers from easily inferring the fact that hiding is applied and the hidden data, and capable of providing a document with natural data close to that of an original content before hiding.

This is because the present invention is configured to search for a content having data similar to those in portions in an original content exclusive of a portion to be hidden, calculate a degree of dissimilarity, which indicates the level of dissimilarity of a content resulting from the search to the portion to be hidden in the content, and select a content replaceable with the content containing the portion to be hidden based on a result of the calculation.

### BRIEF DESCRIPTION OF THE DRAWINGS

FIG. 1 A block diagram showing a configuration of a first embodiment of the present invention.

FIG. 2 A drawing showing a flow chart of processing in the first embodiment of the present invention.

FIG. 3 A block diagram showing a configuration of a second embodiment of the present invention.

FIG. 4 A diagram showing an example of document processing in the first embodiment of the present invention.

FIG. 5 A diagram showing an example of document processing in the second embodiment of the present invention.

### EXPLANATION OF SYMBOLS

1 Document processing apparatus
10 Document database
11 Input section
12 Specifying section
13 Searching section
14 Degree-of-dissimilarity calculating section
15 Selecting section
16 Output section
20 Distance calculation database
24 Degree-of-dissimilarity calculating section

### BEST MODES FOR CARRYING OUT THE INVENTION

A first embodiment of the present invention will be described.

The following description will be made by taking a document as an example of a content, and a document processing apparatus as the content processing apparatus of the present invention.

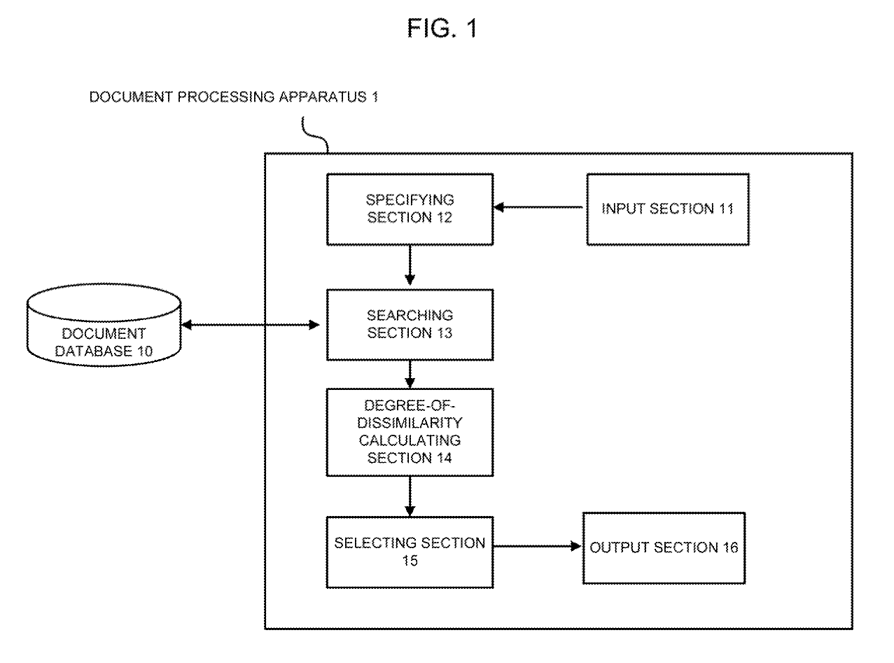

FIG. 1 is a diagram showing an overall configuration of a document processing apparatus in accordance with the first embodiment.

Reference numeral 1 designates the document processing apparatus, which is connected with a document database 10 in which documents are stored.

The document processing apparatus 1 comprises an input section 11, a specifying section 12, a searching section 13, a degree-of-dissimilarity calculating section 14, a selecting section 15, and an output section 16.

The input section 11 is a portion to which a document is input, and it is a scanner or the like.

The specifying section 12 is a device for specification, such as a mouse, for specifying a portion to be hidden in an input document.

The searching section 13 searches for a document having data similar to those in portions in a document, which is an original content, exclusive of the portion to be hidden (the portion desired to be hidden). In particular, one or more similar documents having data similar to those in portions in the input document exclusive of the portion to be hidden are searched from the document database 10. As used herein, a document having data similar to those in portions in a document exclusive of a portion to be hidden refers to a document having substantially the same data as those in portions exclusive of the portion to be hidden. In particular, an allowable similarity is determined beforehand, and only a document(s) having a similarity exceeding the allowable similarity is searched.

The degree-of-dissimilarity calculating section 14 calculates a degree of dissimilarity, which indicates the level of dissimilarity of a similar document resulting from the search by the searching section 13 to a document in the portion specified by the specifying section 12 (portion to be hidden). In particular, the degree-of-dissimilarity calculating section 14 calculates an Euclidean distance between documents as the degree of dissimilarity.

The selecting section 15 selects a document that is most dissimilar to the portion to be hidden as a document to be output based on the degree of dissimilarity calculated by the degree-of-dissimilarity calculating section 14. In particular, a document having the largest degree of dissimilarity is selected out of the plurality of searched similar documents.

The output section 16 outputs a document selected at the selecting section 15.

The document database 10 is a document database that the searching section 13 searches. It stores therein documents that may be output. While the document database 10 is an in-house database provided beforehand, it may be a database configured for search of web documents uploaded to the Internet.

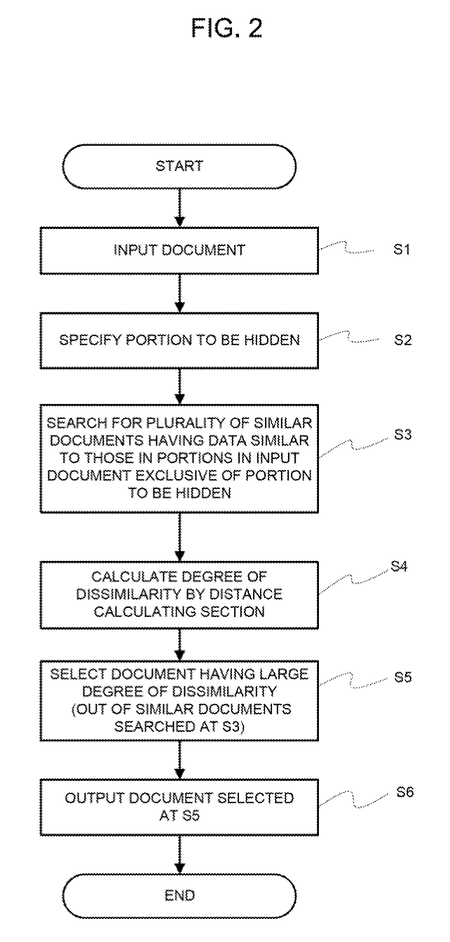

Next, an operation of the document processing apparatus configured as described above will be described with reference to the block diagram in FIG. 1 and flow chart in FIG. 2.

A specific case is assumed in the following description that a member A (a user of the document processing apparatus), who is a member of a new car development project team in a certain automotive manufacturer, has charge of choice of a supplier of engine parts, but the fact that a new car is being developed cannot be disclosed to the supplier because the project is confidential.

The following description will be made assuming that a document input via the input section 11 by the member A is a specification entitled “Specification of High-endurance Engine Parts Required for New Car Development” for choice of a supplier, and “new car development” is specified as the portion to be hidden by the specifying section 12.

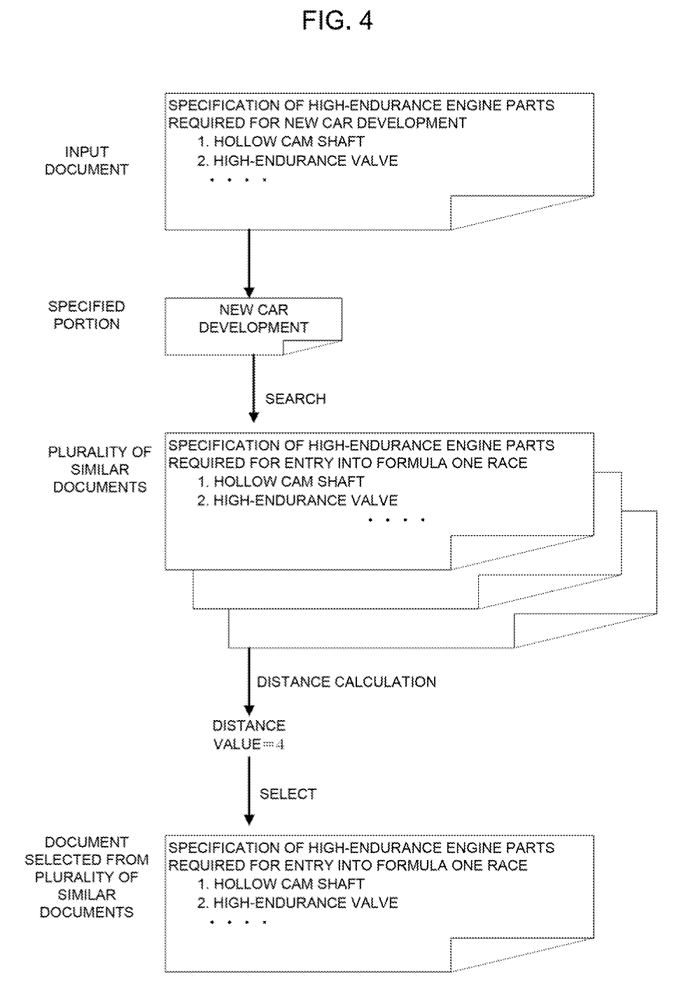

First, as shown in FIG. 4, the document entitled “Specification of High-endurance Engine Parts Required for New Car Development” is input via the input section 11 (Step S1), and “new car development” is specified as the portion to be hidden by the specifying section 12 (Step S2).

At this time, similar document search is performed by the searching section 13. Specifically, the document database 10 is referred to search a plurality of documents having data similar to those in portions in the input document exclusive of the specified portion “new car development” (Step S3). In particular, for example, morphologic analysis is applied to the remaining portion exclusive of “new car development” in the input document, a word vector is created, the word vector having elements of words or phrases represented by independent words resulting from morphologic analysis, such as “high endurance,” “engine parts,” “cam shaft,” and “valve,” a value of a scalar product of the word vector with a word vector that each of the plurality of searched documents originally has is calculated as a degree of similarity, and only documents having a similarity exceeding a prespecified allowable similarity are output as a result of the search. It is also possible to output the documents in sequence starting from that having a higher similarity as the result of the search.

The search by the searching section 13 results in a plurality of similar documents. For example, here, similar documents (1), (2), (3) result from the search: a similar document (1) entitled “Specification of High-endurance Engine Parts Required for Entry into Formula One Race;” a similar document (2) entitled “Specification of High-endurance Valves Required for Development of Trucks;” and a similar document (3) entitled “Hollow Cam Shafts Required for Cars Traveling in Cold Climates.”

While the description here is made assuming that a plurality similar documents result from the search (a document having data similar to those in portions in the input document exclusive of the portion to be hidden), the number of documents resulting from the search may be one.

Subsequently, a distance value between a character string “new car development” in the portion specified in the input document and each character string contained in the documents searched through the search processing at Step S3 is calculated as a degree of dissimilarity by the degree-of-dissimilarity calculating section 14 (Step S4). The distance value is calculated by calculating an Euclidean distance using a character-string-level DP matching technique. In this case, since the character string “new car development” is not present in the similar documents (1), “distance value=4” results. Since the similar documents (2) and (3) contain the characters “development” and “car,” respectively, the calculated distance value is smaller than four.

Next, based on the result of calculation of the degree of dissimilarity by the degree-of-dissimilarity calculating section 14, a document that is most dissimilar to the portion to be hidden, that is, a document having the largest distance value, is selected by the selecting section 15. Since the distance value for the similar document (1) having distance value=4 is the largest here, the similar document (1) is selected as a substitute document for the input document (Step S5). Through output processing by the output section 16, the document entitled “Specification of High-endurance Engine Parts Required for Entry into Formula One Race” is obtained (Step S6). That is, the similar document obtained at that time is a document having the specified portion hidden and having data that is close to that in the input document and yet is less correlated with the specified portion.

While the first embodiment addresses an exemplary case in which the content is a document, the content may be a still image, a moving picture, a voice, or a video. For example, a specified image portion may be hidden by previously storing images in the database in place of documents, causing the degree-of-dissimilarity calculating section to calculate as the distance value a difference of data between a portion of a similar image resulting from search and the image portion desired to be hidden, and causing the selecting section to select an image having a large distance value. Moreover, for example, when a specific person contained in a video is desired to be hidden, a video in which the original person is hidden may be obtained by searching for videos having data similar to those in portions exclusive of the portion of the person to be hidden, and selecting out of the searched videos a video having another person with characteristics apart from those of the person to be hidden (having a large degree of dissimilarity).

While the above embodiment addresses an exemplary case in which the portion to be hidden is directly specified by the member A via the specifying section 12, the present invention is not always limited thereto. For example, when a document format is predetermined, the specifying section may be configured to automatically specify a portion to be hidden in an input document by defining a specifying method beforehand, such as that involving “defining a title portion as a specified portion” or “defining a purpose portion as a specified portion.” In particular, in the first embodiment described above, for example, the phrase “ . . . for New Car Development,” which is a title of the input document, may be specified as the portion to be hidden by defining beforehand a specifying method of “specifying a title portion as the portion to be hidden.”

Moreover, while the above embodiment addresses an exemplary case in which the portion to be hidden (specified portion) is a character string “New Car Development,” the specified portion may be a word, a document, or part of a document.

Furthermore, while the above embodiment has a configuration in which the degree-of-dissimilarity calculating section calculates the distance between a character string contained in a similar document output as a result of search and a specified portion, distance calculation may be applied to a distance between a whole similar document and a specified portion.

In addition, while in the above embodiment, the searching section and degree-of-dissimilarity calculating section are separate/independent constituent sections, the present invention is not always limited thereto. The searching section for searching similar documents and the degree-of-dissimilarity calculating section for calculating a degree of dissimilarity of a similar document to a document in a portion to be hidden may be provided as the same constituent section.

Moreover, while in the above embodiment, calculation of the distance from a specified portion is applied to a “Title” portion in a similar document, the present invention is not always limited thereto. For example, when a format is predetermined, the specifying section and degree-of-dissimilarity calculating section may be configured to apply distance calculation to the “Purpose” portion or “Summary of Specification” portion, not limited to the “Title” portion, or configured to apply distance calculation to these plurality of portions.

Further, while in the above embodiment, the Euclidean distance between documents is calculated as the degree of dissimilarity, the present invention is not always limited thereto. For example, a total sum of co-occurrence frequencies between words or a total sum of amounts of mutual information may be calculated as the degree of dissimilarity insofar as the degree of dissimilarity can be quantitatively measured.

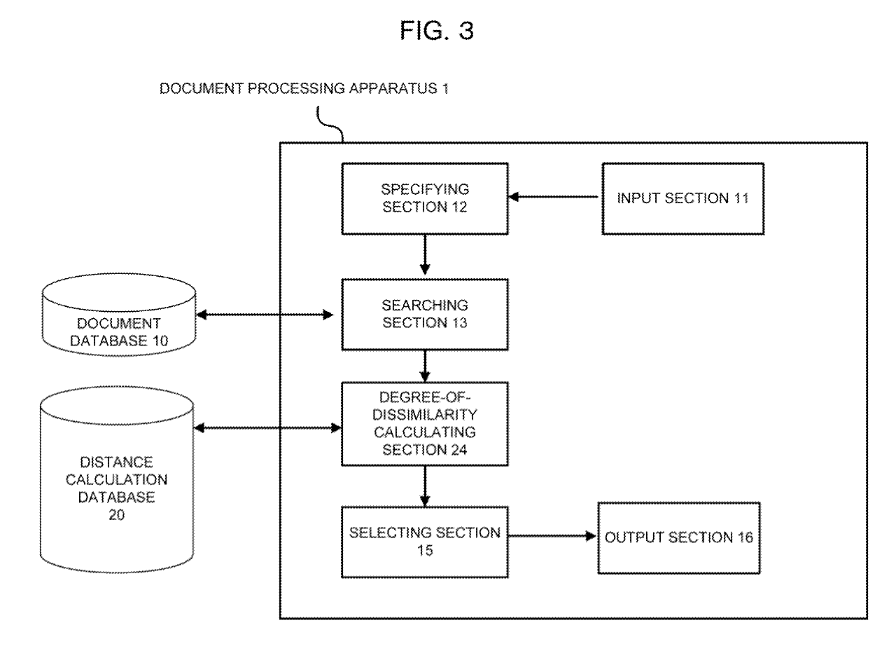

Next, a second embodiment will be described with reference to FIG. 3. FIG. 3 is an overall block diagram of a content processing apparatus in accordance with the second embodiment.

Again, the following description will be made assuming that a content is a document, and the content processing apparatus in the present invention is a document processing apparatus.

Referring to FIG. 3, according to the second embodiment, the degree-of-dissimilarity calculating section 14 in the first embodiment is replaced with a degree-of-dissimilarity calculating section 24, and a distance calculation DB 20 is additionally provided.

The distance calculation database 20 is a database in which word statistic information, such as the co-occurrence frequency for words, mutual information for words, is stored.

The degree-of-dissimilarity calculating section 24 calculates a degree of dissimilarity between a specified portion and a searched document based on the statistic information for words contained in the distance calculation database 20. In particular, the total sum of the co-occurrence frequencies for words (or character strings) contained in the document resulting from search by the searching section 13 and words (or character word string) contained in the document in the portion to be hidden is calculated as the degree of dissimilarity. As used herein, the co-occurrence frequency refers to a frequency at which specific words or the like appear in documents at the same time.

Since the function of other constituent portions is similar to that in the first embodiment, similar constituent portions are designated by similar reference symbols/numerals to those in the first embodiment and detailed description thereof will be omitted.

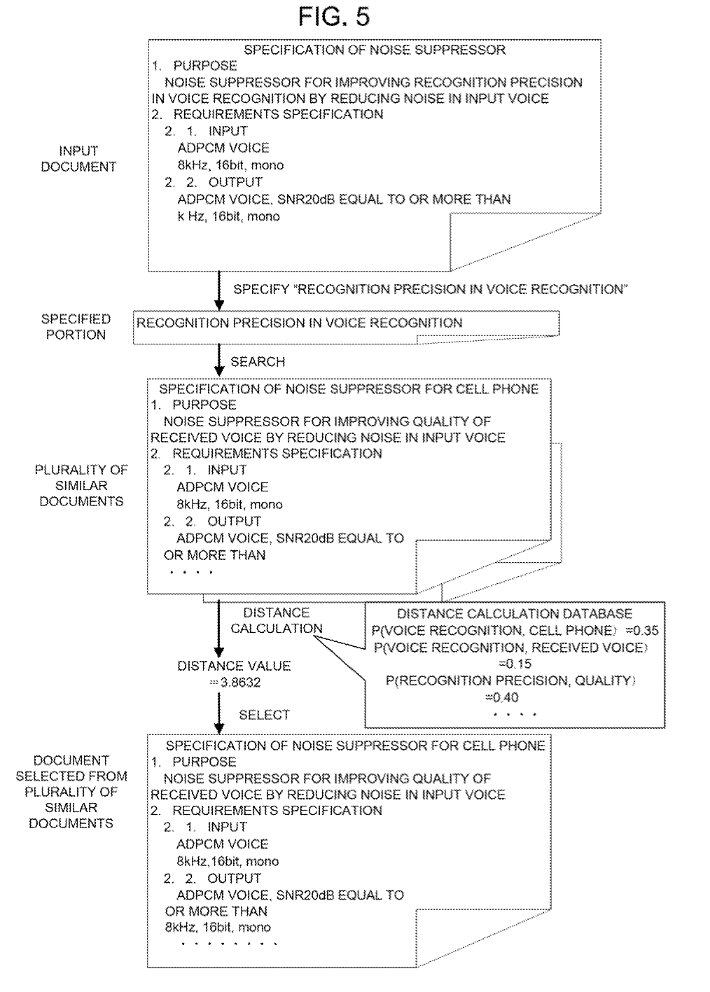

Next, an operation in the second embodiment will be described with reference to FIG. 5.

The description here will be made assuming that a member B (a user of the document processing apparatus), who is a member of a voice recognition software development project team in a certain manufacturer, has charge of outsourcing for a noise suppressor for an input voice. In this case, the following description will be made assuming a case that the fact that voice recognition software is being developed cannot be disclosed to the outsourcing firm because patent application for the voice recognition is delayed.

Now “Specification of Noise Suppressor” for outsourcing development of the voice recognition software is input by the member B via the input section 11. Then, “recognition precision in voice recognition” is specified as the portion to be hidden via the specifying section 12. Thus, the specified portion, which is the portion to be hidden, is “recognition precision in voice recognition.”

Next, a document having data similar to those in portions exclusive of the specified portion is searched for from the document database 10 by the searching section 13. Specifically, similar documents in which “noise suppressor,” “reduction,” “ADPCM voice,” “8 kHz” and the like, except “recognition precision in voice recognition,” in the input document are used are searched for from the document database 10 by the searching section 13. As a result of search by the searching section 13, a plurality of similar documents are obtained as shown in FIG. 5.

Subsequently, the degree-of-dissimilarity calculating section 24 calculates a degree of dissimilarity of the specified portion “recognition precision in voice recognition” to each of the plurality of similar documents resulting from the search by the searching section 13 while referring to the word statistic information contained in the distance calculation database 20.

The calculation of the degree of dissimilarity by the degree-of-dissimilarity calculating section 24 is particularly performed as described below. First, a co-occurrence frequency is calculated between each of words “voice recognition” and “recognition precision” constituting the specified portion “recognition precision in voice recognition,” and each of words “cell phone,” “received voice,” “quality” contained in one of the plurality of similar documents that is subjected to distance calculation (for example, “Specification of Noise Suppressor for Cell phone”). Then, a total sum of logarithmic values of the co-occurrence frequencies calculated for combinations of these words is calculated as the degree of dissimilarity.

A specific formula for calculating the degree of dissimilarity Dist is given by an example of EQ. (1):

Dist=−Σ log(P(Wi,Wj)) EQ. (1)

(where Wi represents a word contained in the specified portion, and Wj represents a word contained in the similar document.)

The calculation according to EQ. (1) gives a result, for example “distance value=3.8632.”

Next, based on the calculated degree of dissimilarity, a document having the largest degree of dissimilarity (a document that is most dissimilar to the portion to be hidden) is selected at the selecting section 15. Thus, for example, a document entitled “Specification of Noise Suppressor for Cell Phone” is obtained.

Thus, there is obtained a document having the specified portion hidden and having data that is close to that in the input document and yet is less correlated with the specified portion.

While the second embodiment uses word statistic information as the distance calculation database and configures the degree-of-dissimilarity calculating section to calculate the degree of dissimilarity based on the co-occurrence frequency between words, the present invention is not always limited thereto. For example, the degree of dissimilarity may be calculated based on mutual information for words. Further, a thesaurus (a dictionary of synonyms) may be employed as the distance calculation database to calculate the degree of dissimilarity by a total sum of distances in the thesaurus between words.

In particular, a similar document suitable for hiding the specified portion can be obtained by calculating the degree of dissimilarity by a total sum of the distances in the thesaurus between words contained in the specified portion (“voice recognition,” “recognition precision”) and those contained in the searched document (“cell phone,” “received voice,” “quality,” etc.), i.e., a total sum of the inter-layer distances between layers indicating relevance of words, and selecting a document having a large degree of dissimilarity. A specific formula for calculating the degree of dissimilarity Dist in this case is given by an example of EQ. (2):

Dist=−Σ(D(Wi,Wj)) EQ. (2)

(where Wi represents a word contained in the specified portion, Wj represents a word contained in the similar document, and D(Wi, Wj) represents a distance in the thesaurus between Wi and Wj.)

Moreover, when performing distance calculation, the degree of dissimilarity may be corrected by referring to uploaded web information, calculating the occurrence frequency and/or appearance time of the searched similar documents, and giving weighting to a document that appears at a high frequency or appears recently.

Alternatively, when calculating the degree of dissimilarity, a configuration in which the occurrence frequency of the searched similar document in the web is added to the degree of dissimilarity may be adopted. Such correction is advantageous in correctly communicating specifications to an outsourcing firm because documents having higher occurrence frequency and/or public awareness are preferentially selected. Moreover, the correction may be made to select a document whose appearance time is more recent, in place of that with a higher occurrence frequency, or the appearance time and occurrence frequency may be combined.

Furthermore, when calculating the degree of dissimilarity, in a case, for example, that words such as “voice recognition” and “recognition precision” contained in the specified portion are also present in a searched similar document, correction may be made to subtract the frequency at which these words appear in the searched similar document from the degree of dissimilarity. By doing so, documents having a larger distance from the specified portion, i.e., documents having a portion to be hidden (specified portion) that is difficult to infer, can be preferentially selected, so that information leakage to the outsourcing firm can be more effectively prevented.

The present application claims priority based on Japanese Patent Application No. 2007-119393 filed on Apr. 27, 2007, disclosure of which is incorporated herein in its entirety.

### APPLICABILITY IN INDUSTRY

The present invention may be applied to uses for outsourcing/supply such as document creation, moving picture production, etc. in a project or the like in the form in which a plurality of companies, departments, or individuals are cooperated to achieve mission.

1-27. (canceled)

28. A content processing apparatus comprising:
searcher for searching for a content having contents similar to those in portions in an original content exclusive of a portion to be hidden; and
calculator for calculating a degree of dissimilarity, which indicates the level of dissimilarity of each content obtained by said searcher to the portion to be hidden in said original content.

29. A content processing apparatus according to claim 28, wherein said searcher searches a content having the substantially same contents as those in the portions exclusive of the portion to be hidden by, based on a prespecified allowable similarity, searching for a content having a similarity exceeding said similarity.

30. A content processing apparatus according to claim 28, wherein the apparatus comprises selector for selecting a content that is most dissimilar to said portion to be hidden out of contents searched by said searcher based on the degree of dissimilarity calculated by said calculator.

31. A content processing apparatus according to claim 28, wherein
said content is a document, and
said calculator calculates said degree of dissimilarity as an Euclidean distance between a document resulting from search by said searcher and a document contained in said portion to be hidden.

32. A content processing apparatus according to claim 28, wherein said content processing apparatus comprises a distance calculation database containing word statistic information, and
said calculator refers to said distance calculation database to calculate the degree of dissimilarity as a total sum of co-occurrence frequencies or a total sum of amounts of mutual information of words contained in the document in the content resulting from search by said searcher and words contained in the document in said portion to be hidden.

33. A content processing apparatus according to claim 28, wherein said content processing apparatus comprises a thesaurus as a distance calculation database containing word statistic information, and
said calculator refers to said thesaurus to calculate said degree of dissimilarity as a total sum of distances in the thesaurus between words contained in the similar document resulting from search by said searcher and words contained in a specified range in said input document.

34. A content processing apparatus according to claim 28, wherein said calculator is configured to calculate at least one of an occurrence frequency of words or character strings contained in the document resulting from search by said searcher and an appearance time of said document resulting from said search, and correct said degree of dissimilarity based on a result of the calculation.

35. A content processing apparatus according to claim 34, wherein the correction of the degree of dissimilarity at said calculator is correction for adding the calculated occurrence frequency to said degree of dissimilarity.

36. A content processing apparatus according to claim 34, wherein the correction of the degree of dissimilarity at said calculator is correction for calculating a differential value between the calculated appearance time and a current time, and adding a weighting value depending upon the differential value to said degree of dissimilarity.

37. A content processing apparatus according to claim 28, wherein the apparatus comprises specifying device for specifying a portion to be hidden in an input document.

38. A content processing apparatus according to claim 37, wherein said specifying device is configured to, when a document format is defined beforehand, specify a document, a word, or a word series input in a predetermined portion of said document format.

39. A content processing apparatus according to claim 28, wherein
said content is an image, and
said calculator calculates said degree of dissimilarity as a difference between data of an image resulting from search by said searcher and image data contained in said portion to be hidden.

40. A content processing method comprising:
a searching step of searching for a content having contents similar to those in portions in an original content exclusive of a portion to be hidden;
a calculating step of calculating a degree of dissimilarity, which indicates the level of dissimilarity of each content obtained by said searching step to the portion to be hidden in said original content; and
a selecting step of selecting a content having a high level of dissimilarity to said portion in the content to be hidden out of contents searched by said searching step based on the degree of dissimilarity calculated by said calculating step.

41. A content processing method according to claim 40, wherein said searching step specifies an allowable similarity beforehand, and searches a content having the substantially same contents as those in the portions exclusive of the portion to be hidden by searching for a content having a similarity exceeding said specified similarity.

42. A content processing method according to claim 40, wherein said selecting step comprises selecting a content that is most dissimilar to said portion to be hidden out of contents searched by said searching step based on the degree of dissimilarity calculated by said calculating means.

43. A content processing method according to claim 40, wherein
said content is a document, and
said calculating step calculates said degree of dissimilarity as an Euclidean distance between a document resulting from search by said searching step and a document contained in said portion to be hidden.

44. A content processing method according to claim 40, wherein said calculating step refers to a distance calculation database containing word statistic information to calculate the degree of dissimilarity as a total sum of co-occurrence frequencies or a total sum of amounts of mutual information of words contained in the document in the content resulting from search by said searching step and words contained in the document in said portion to be hidden.

45. A content processing method according to claim 40, wherein said calculating step refers to a thesaurus serving as a distance calculation database containing word statistic information to calculate said degree of dissimilarity as a total sum of distances in the thesaurus between words contained in the similar document resulting from search by said searching step and words contained in a specified range in said input document.

46. A content processing method according to claim 40, wherein said calculating step calculates at least one of an occurrence frequency of words or character strings contained in the document resulting from search by said searching step and an appearance time of said document resulting from said search, and corrects said degree of dissimilarity based on a result of the calculation.

47. A content processing method according to claim 46, wherein the correction of the degree of dissimilarity at said calculating step is correction for adding the calculated occurrence frequency to said degree of dissimilarity.

48. A content processing method according to claim 46, wherein the correction of the degree of dissimilarity at said calculating step is correction for calculating a differential value between the calculated appearance time and a current time, and adding a weighting value depending upon the differential value to said degree of dissimilarity.

49. A content processing method according to claim 40, wherein the content processing method comprises a specifying step of specifying a portion to be hidden in an input document.

50. A content processing method according to claim 49, wherein, when a document format is defined beforehand, said specifying step specifies a document, a word, or a character string input in a predetermined portion of said document format.

51. A content processing method according to claim 40, wherein
said content is an image, and
said calculating step calculates said degree of dissimilarity as a difference between data of an image resulting from search by said searching step and image data contained in said portion to be hidden.

52. A program for an information processing apparatus, said program causing the information processing apparatus to function as:
searching processing of searching for a content having contents similar to those in portions in an original content exclusive of a portion to be hidden;
calculating processing of calculating a degree of dissimilarity, which indicates the level of dissimilarity of each content obtained by said searching processing to the portion to be hidden in said content; and
selecting processing of selecting a content having a high level of dissimilarity to said portion in the content to be hidden out of contents searched by said searching processing based on the degree of dissimilarity calculated by said calculating processing.

53. A program according to claim 52, wherein said searching processing comprises specifying an allowable similarity beforehand, and searching a content having the substantially same contents as those in the portions exclusive of the portion to be hidden by searching for a content having a similarity exceeding said specified similarity.

54. A program according to claim 52, wherein said selecting processing comprises selecting a content that is most dissimilar to said portion to be hidden out of contents searched by said searching step based on the degree of dissimilarity calculated by said calculating processing.
